(19) United States
(12) Patent Application Publication
(10) Pub. No.: US 2017/0186571 A1
(43) Pub. Date: Jun. 29, 2017

(54) BACKLIGHT KEYBOARD

(71) Applicant: Jiangsu Transimage Technology Co., Ltd, Yangzhou City (CN)

(72) Inventor: Weimin Zou, Yangzhou City (CN)

(21) Appl. No.: 15/004,489

(22) Filed: Jan. 22, 2016

(30) Foreign Application Priority Data
Dec. 24, 2015 (CN) CN 2015109822415
Dec. 30, 2015 (CN) CN 2015110236354

(51) Int. Cl. H01H 13/83; H01H 13/02

(52) U.S. Cl. CPC H01H 13/83; H01H 13/023; H01H 2219/062; H01H 2219/06

(57) ABSTRACT

A backlight keyboard, including a keycap, an elastic body, a conducting circuit board and a base plate from top to bottom, wherein the keycap and the base plate are coupled through a pair of scissors, the elastic body is used for supporting the keycap and transmitting pressure on the keycap to the conducting circuit board to conduct a circuit, the backlight keyboard further includes a backlight module, the backlight module includes a light emitting diode connected with the conducting circuit board and a light guide plate transmitting the light given out from the light emitting diode to the keycap.

### TECHNICAL FIELD

The invention relates to a keyboard, and more particular to a backlight keyboard.

### BACKGROUND

A backlight keyboard is mainly reflected in that keyboard buttons or a panel gives out light, button letters can be clearly seen at night without turning a lamp on. In this way, it is quite convenient for people who deal with affairs at night and the appearance of the keyboard is extremely attractive. When a computer receives a key knocking-on instruction, the keyboard buttons are connected with an optical signal of a light emitting diode to light.

The backlight keyboard is mainly composed of a keyboard component and a backlight module. Traditional backlight module generally includes a flexible circuit board, and the flexible circuit board is connected with the light emitting diode so as to achieve the supply of the light source. But the cost of the flexible circuit board is very high, so that the production cost of the backlight keyboard is greatly increased compared with the non-backlight keyboard. The traditional backlight module further includes a light guide plate, a reflecting sheet and a shading sheet, the existence of the flexible circuit board, the reflecting sheet and the shading sheet promote the thickness of the backlight keyboard to greatly increase, so that the common use of the material of the backlight keyboard and the non-backlight keyboard cannot be achieved and the backlight keyboard cannot be applicable to some flight-thin structures. In this way, it is urgent to find a method to solve the above problems.

### SUMMARY

Invention object: the object of the invention is to provide a backlight keyboard capable of effectively saving cost and reducing the thickness of the keyboard.

Technical scheme: a backlight keyboard according to the invention includes a keycap, an elastic body, a conducting circuit board and a base plate from top to bottom, wherein the keycap and the base plate are coupled through a pair of scissors, the elastic body is used for supporting the keycap and transmitting pressure on the keycap to the conducting circuit board to conduct a circuit, the backlight keyboard further includes a backlight module, the backlight module includes a light emitting diode connected with the conducting circuit board and a light guide plate transmitting the light given out from the light emitting diode to the keycap.

To be specific: the combination mode of the conducting circuit board and the backlight module can include four modes as follows:

First combination mode: the light emitting diode is connected with any one layer of the conducting circuit board, and the light guide plate is located below the conducting circuit board.

A shading sheet can be arranged above the light guide plate, or shading ink covers the surface of the light guide plate. The light source is only reflected in the keycap through the shading sheet or the shading ink to centrally utilize the light source. The shading sheet is replaced by the shading ink, which can further reduce the thickness of the backlight module.

Second combination mode: the conducting circuit board includes an upper layer circuit board, a lower layer circuit board and an insulating layer, the insulating layer is located between the upper layer circuit board and the lower layer circuit board, the light emitting diode is connected with the upper layer circuit board or the lower layer circuit board, the light guide plate is located below the conducting circuit board, and the shading ink covers the surface of the lower layer circuit board. The lower layer circuit board has the shading effect as well, so the use of the shading sheet can be cancelled to further reduce the thickness of the backlight module.

Third combination mode: the conducting circuit board includes an upper layer circuit board and an insulating layer located below the upper layer circuit board, the light guide plate is located below the insulating layer, and the surface of the light guide plate is equipped with circuits. The lower layer circuit board is replaced by the light guide plate with the circuits, which reduces the whole thickness of the backlight keyboard compared to the first mode and the second mode.

The shading ink covers the surface of the insulating layer. The insulating has the shading effect as well, so the use of the shading sheet can be cancelled to reduce the thickness of the backlight module.

In the above three modes, preferably, a reflecting sheet can be arranged below the light guide plate, or reflective ink covers the lower surface of the light guide plate. Part of diffused light is gathered and recovered by the reflecting sheet or the reflective ink and reflected to the keycap, which can further improve the brightness of the keyboard. The reflective sheet is replaced by the reflective ink, so that the thickness of the backlight module is reduced to further reduce the thickness of the backlight keyboard.

Fourth combination mode: the conducting circuit board includes an upper layer circuit board and a lower layer circuit board, and the light guide plate is located between the upper layer circuit board and the lower layer circuit board. The insulating layer is replaced by the light guide plate, which reduces the whole thickness of the backlight keyboard compared to the first mode and the second mode.

The shading ink covers the surface of the upper layer circuit board. The upper layer circuit board has the shading effect as well, which can cancel the use of the shading sheet.

The reflective ink covers the surface of the lower layer circuit board. The lower layer circuit board has the effect of the reflecting sheet as well, which can cancel the use of the reflecting sheet.

Beneficial effect: compared to the prior art, the invention has the advantages as follows: (1) for the backlight keyboard according to the invention, the light emitting diode in the backlight module is connected with the conducting circuit board to provide a light source and a flexible circuit board in the traditional backlight module is cancelled, so that the production cost is greatly reduced; at the same time, the space is saved compared to the original backlight module, the thickness of the whole backlight keyboard is reduced and the common use of the material of the backlight keyboard and the non-backlight keyboard is improved, so that the cost of the material and the mould is reduced at the same time; (2) the reflecting sheet and the shading sheet are replaced by printing the reflective ink and the shading ink according to the invention, which can further reduce the thickness of the backlight module; the insulating layer or the lower layer circuit board of the conducting circuit board can further be replaced by the light guide plate in the invention so as to further reduce the thickness of the whole backlight keyboard, the backlight keyboard at least can only include a three-layer structure at the premise of keeping the function of the backlight keyboard, so the keyboard is more light and thinner and more practical.

### BRIEF DESCRIPTION OF THE DRAWINGS

FIG. 1 is a schematic structural diagram of a backlight keyboard in the prior art;

FIG. 2 is a schematic structural diagram of a backlight module in the prior art;

FIG. 3 is an assembly drawing of a backlight keyboard according to the invention;

FIG. 4 is a schematic structural diagram of a first combination of a conducting circuit board and a backlight module according to the invention;

FIG. 5a is a schematic structural diagram of a second combination of a conducting circuit board and a backlight module according to the invention, wherein a light emitting diode is connected with an upper layer circuit board;

FIG. 5b is a schematic structural diagram of a second combination of a conducting circuit board and a backlight module according to the invention, wherein a light emitting diode is connected with a lower layer circuit board;

FIG. 6 is a schematic structural diagram of a third combination of a conducting circuit board and a backlight module according to the invention;

FIG. 7a is a schematic structural diagram of a fourth combination of a conducting circuit board and a backlight module according to the invention, wherein a light emitting diode is connected with an upper layer circuit board; and

FIG. 7b is a schematic structural diagram of a fourth combination of a conducting circuit board and a backlight module according to the invention, wherein a light emitting diode is connected with a lower layer circuit board.

### DETAILED DESCRIPTION OF THE PREFERRED EMBODIMENTS

The technical scheme of the invention is further described hereinafter with reference to the drawings.

As shown in FIG. 1, the traditional backlight keyboard is generally composed of a keycap 1, an elastic body 5, a conducting circuit board 4, a base plate 2 and a backlight module 6 from top to bottom, the backlight module 6 is adhered below the base plate 2 of the keyboard, wherein the keycap 1 and the base plate 2 are coupled via a pair of scissors 3. In the figure, the direction of the arrow expresses the light transmitting direction, the base plate 2 is provided with a plurality of holes, and the light is given out from the backlight module 6 and is transmitted to the keycap 1 through the holes in the base plate 2.

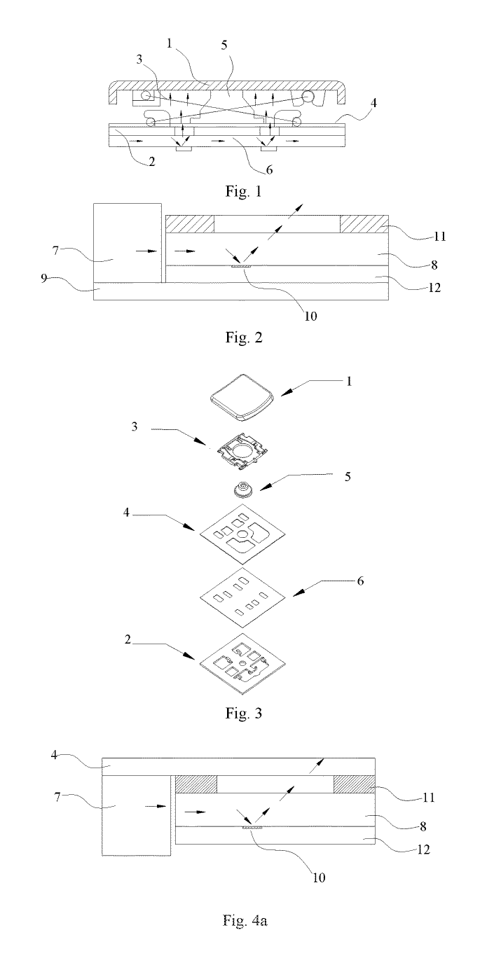

As shown in FIG. 2, the traditional backlight module 6 includes a light emitting diode 7, a light guide plate 8, a flexible circuit board 9, a shading sheet 11 and a reflecting sheet 12, the light emitting diode 7 is adhered to the flexible circuit board 9, the light given out from the light emitting diode 7 is reflected to the keycap 1 through a light guide point 10 of the light guide plate 8 to achieve the function of lighting at the bottom of the keyboard; but the cost of the flexible circuit board 9 is very high so that the production cost of the backlight keyboard is greatly increased compared to the non-backlight keyboard; moreover, the existence of the flexible circuit board makes the thickness of the backlight keyboard increased compared to the non-backlight keyboard so that the common use of the material of the backlight keyboard and the non-backlight keyboard cannot be achieved, and the thicker backlight keyboard is also not beneficial to the application in the laptop.

As shown in FIG. 3, the backlight keyboard in the invention includes a keycap 1 and a base plate 2, the keycap 1 and the base plate 2 are connected through a pair of scissors 3, an elastic body 5 and a conducting circuit board 4 are arranged between the keycap 1 and the base plate 2, the elastic body 5 is used for supporting the keycap 1 and transmitting the pressure on the keycap 1 to the conducting circuit board 4 to conduct the circuit. The backlight keyboard further includes a backlight module 6, the backlight module 6 can be arranged below the base plate and can also be arranged between the conducting circuit board 4 and the base plate 2. When the backlight module 6 is arranged between the conducting circuit board 4 and the base plate 2, the light is directly given out from the front of the backlight module 6 and irradiates the keycap 1 through the conducting circuit board 4 or the hole in the conducting circuit board 4 to enable the surface of the keyboard to give out light. Compared to the traditional backlight keyboard, it is simpler and more direct to utilize the light source, and the whole strength of the keyboard is better. At the same time, the shape of the backlight keyboard can be kept consistent with the shape of the non-backlight keyboard, which is more beneficial to assembling the system.

The traditional backlight module and the conducting circuit board are improved according to the invention, and the light emitting diode 7 in the backlight module 6 is directly connected with the conducting circuit board 4 to cancel the use of the flexible circuit board. In this way, on one hand, the space of the original backlight module is saved, the thickness of the backlight keyboard is reduced, the common use of the material of the backlight keyboard and the non-backlight keyboard is improved, and the cost of the material and the mould is reduced at the same time; and on the other hand, the production cost of the backlight keyboard is greatly reduced.

The combination mode of the conducting circuit board 4 and the backlight module 6 of the invention mainly includes four modes as follows.

First combination mode: as shown in FIG. 4, the backlight module 6 includes a light emitting diode 7 and a light guide plate 8, the light emitting diode 7 is connected with the conducting circuit board 4, the light guide plate 8 is located below the conducting circuit board 4, the light given out from the light emitting diode 7 enters into the light guide plate 8 and is transmitted to the keycap 1 through a light guide point 10 of the light guide plate 8. The conducting circuit board 4 generally includes an upper layer circuit board, a lower layer circuit board and an insulating layer, the insulating layer is located between the upper layer circuit board and the lower layer circuit board, and the light emitting diode 7 can be connected to any one layer of the conducting circuit board.

Compared to the traditional backlight module, the flexible circuit board is cancelled. A shading sheet 11 can be arranged above the light guiding plate 8, so that the light source is only reflected to the keycap 1 and is centrally utilized; moreover, a reflecting sheet 12 can be arranged below the light guide plate 8, and part of diffused light is recovered and is reflected to the keycap 1, so that the brightness of the backlight keyboard can be further improved.

Shading ink and reflective ink can be coated on the upper surface and the lower surface of the light guide plate 8 respectively to replace the shading sheet 11 and the reflecting sheet 12. Compared to the traditional backlight module, the shading sheet and the reflecting sheet are cancelled and the thickness of the backlight keyboard can be further reduced, so that the cost is reduced.

Second combination mode: as shown in FIG. 5a and FIG. 5b, the conducting circuit board 4 includes an upper layer circuit board 401, a lower layer circuit board 402 and an insulating layer 403, the insulating layer 403 is located between the upper layer circuit board 401 and the lower layer circuit board 402, the backlight module 6 includes a light emitting diode 7 and a light guide plate 8, the light emitting diode 7 is connected with the upper layer circuit board 401 or the lower layer circuit board 402, and the light guide plate 8 is located below the conducting circuit board. It is basically the same as the structure of the backlight module in the first mode, but the main difference is that the effect of the shading sheet is achieved by coating the shading ink on the surface of the lower layer circuit board 402.

Compared to the traditional backlight module, the flexible circuit board is cancelled and the shading sheet is cancelled at the same time.

Similarly, a reflecting sheet 12 can be arranged below the light guide plate 8 or reflective ink can be coated on the lower surface of the light guide plate 8, so that the brightness of the backlight keyboard is further improved.

The above first mode and the second mode mainly improve the structure of the backlight module 6 and can further improve the structure of the conducting circuit board 4 and the backlight module 6 at the same time, so that the whole thickness of the backlight keyboard is further reduced. The specific improvement mode is the third combination mode and the fourth combination mode thereinafter.

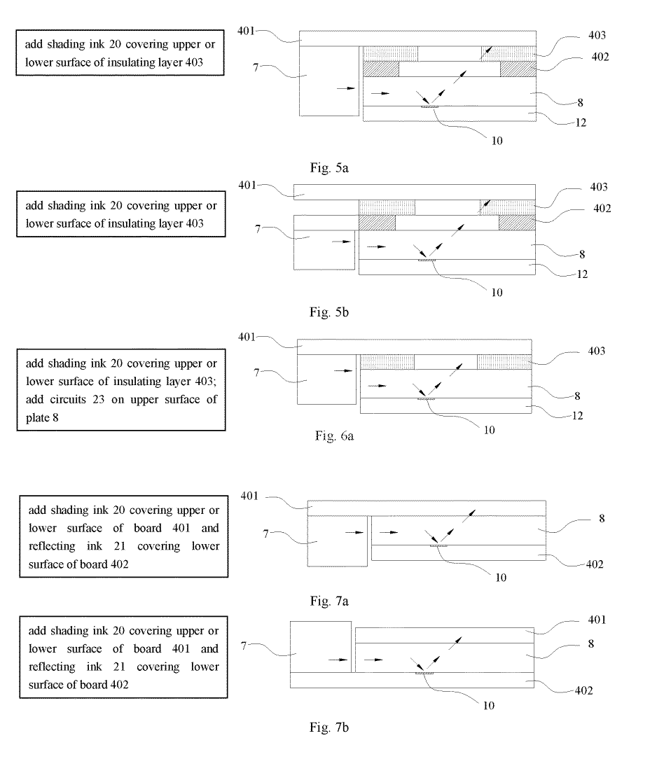

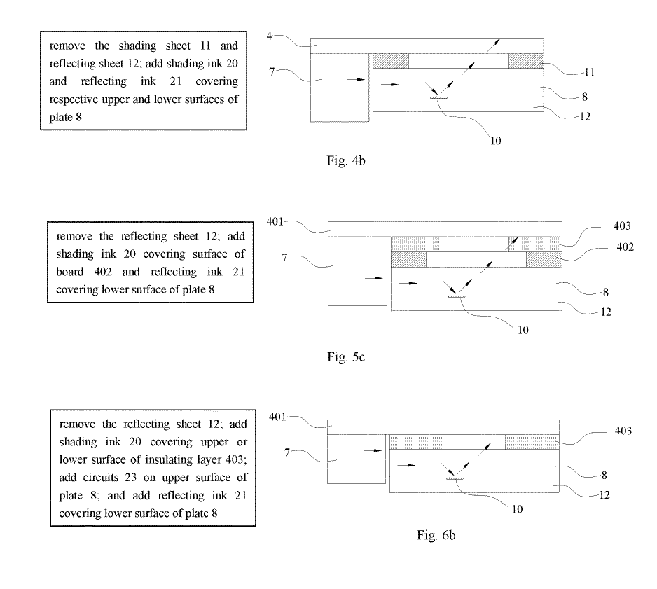

Third combination mode: as shown in FIG. 6, the backlight module 6 includes a light emitting diode 7 and a light guide plate 8, the light emitting diode 7 is connected with an upper layer circuit plate 401 of the conducting circuit board 4, the surface of the light guide plate 8 is equipped with circuits which are arranged below an insulating layer 403 of the conducting circuit plate 4 to achieve the light guide function and replace the original lower layer circuit board as well, and the conducting circuit board 4 is equivalent to be composed of the upper layer circuit board 401, the insulating layer 403 and the light guide plate 8 with the circuits.

Compared to the traditional backlight keyboard, not only the flexible circuit board is cancelled, but also the lower layer circuit board in the conducting circuit board is cancelled, so that the thickness of the conducting circuit board and the thickness of the backlight module are reduced at the same time; moreover, compared to the first mode and the second mode, the thickness of the whole backlight keyboard is further reduced, and the keyboard is lighter and thinner.

At the same time, shading ink can be coated on the upper surface or the lower surface of the insulating layer 403 to replace a shading sheet in the traditional backlight module; and a reflecting sheet 12 can be arranged below the light guide plate 8, or reflective ink can be coated on the lower surface of the light guide plate 8 to replace the reflecting sheet in the traditional backlight module to reduce the thickness of the backlight module, so that the material is saved.

Fourth combination mode: as shown in FIG. 7a and FIG. 7b, the backlight module 6 includes a light emitting diode 7 and a light guide plate 8, the light emitting diode 7 is connected with an upper layer circuit plate 401 or a lower layer circuit board 402 of the conducting circuit board 4, and the light guide plate 8 is arranged between the upper layer circuit plate 401 and the lower layer circuit board 402 to achieve the light guide function and replace the original insulating layer as well, and the conducting circuit board 4 is equivalent to be composed of the upper layer circuit board 401, the light guide plate 8 and the lower layer circuit board 402.

Compared to the traditional backlight keyboard, not only the flexible circuit board is cancelled, but also the insulating layer in the conducting circuit board is cancelled, so that the thickness of the conducting circuit board and the thickness of the backlight module are reduced at the same time; moreover, compared to the first mode and the second mode, the thickness of the whole backlight keyboard is further reduced, and the keyboard is lighter and thinner.

At the same time, after the upper surface or the lower surface of the upper layer circuit board 401 is coated with the shading ink, the upper layer circuit board 401 has the function of the shading sheet. Compared to the traditional backlight, the shading sheet is cancelled. After the lower surface of the lower layer circuit board 402 is coated with the reflective ink, the lower layer circuit board 402 has the function of the reflecting sheet. Compared to the backlight module, the reflecting sheet is cancelled. In this way, the thickness of the backlight module is reduced, so that the material is saved.

The above third mode and the fourth mode are most preferable. The whole backlight keyboard is lighter and thinner, the thickness of the backlight keyboard is as equal as the thickness of the non-backlight keyboard. In this way, the common use of the material of the backlight keyboard and the non-backlight keyboard can be achieved, and the cost of the material and mould of the keyboard can be reduced as well; moreover, the assembly is simpler and the whole performance is better.

1. A backlight keyboard, wherein the backlight keyboard comprises a keycap, an elastic body, a conducting circuit board and a base plate from top to bottom, the keycap and the base plate are coupled through a pair of scissors, the elastic body is used for supporting the keycap and transmitting pressure on the keycap to the conducting circuit board to conduct a circuit, the backlight keyboard further comprises a backlight module, the backlight module comprises a light emitting diode connected with the conducting circuit board and a light guide plate transmitting the light given out from the light emitting diode to the keycap,
wherein the conducting circuit board comprises an upper layer circuit board, a lower layer circuit board and an insulating layer, the insulating layer is located between the upper layer circuit board and the lower layer circuit board, the light emitting diode is connected with the upper layer circuit board or the lower layer circuit board, and shading ink is coated on and covers the surface of the lower layer circuit board.

2. The backlight keyboard according to claim 1, wherein the light guide plate is located below the conducting circuit board.

3. (canceled)

4. (canceled)

5. A backlight keyboard, wherein the backlight keyboard comprises a keycap, an elastic body, a conducting circuit board and a base plate from top to bottom, the keycap and the base plate are coupled through a pair of scissors, the elastic body is used for supporting the keycap and transmitting pressure on the keycap to the conducting circuit board to conduct a circuit, the backlight keyboard further comprises a backlight module, the backlight module comprises a light emitting diode connected with the conducting circuit board and a light guide plate transmitting the light given out from the light emitting diode to the keycap,
wherein the conducting circuit board comprises an upper layer circuit board and an insulating layer, the insulating layer is located below the upper layer circuit board, the light guide plate is located below the insulating layer, and the surface of the light guide plate is equipped with circuits.

6. The backlight keyboard according to claim 5, wherein the shading ink is coated on and covers the surface of the insulating layer.

7. The backlight keyboard according to claim 2, wherein a reflecting sheet is arranged below the light guide plate, or reflective ink covers the lower surface of the light guide plate.

8. A backlight keyboard, wherein the backlight keyboard comprises a keycap, an elastic body, a conducting circuit board and a base plate from top to bottom, the keycap and the base plate are coupled through a pair of scissors, the elastic body is used for supporting the keycap and transmitting pressure on the keycap to the conducting circuit board to conduct a circuit, the backlight keyboard further comprises a backlight module, the backlight module comprises a light emitting diode connected with the conducting circuit board and a light guide plate transmitting the light given out from the light emitting diode to the keycap,
wherein the conducting circuit board comprises an upper layer circuit board and a lower layer circuit board, the light emitting diode is connected to the lower layer circuit board, and the light guide plate is located between the upper layer circuit board and the lower layer circuit board.

9. The backlight keyboard according to claim 8, wherein shading ink covers the surface of the upper layer circuit board.

10. The backlight keyboard according to claim 8, wherein reflective ink covers the surface of the lower layer circuit board.

11. The backlight keyboard according to claim 9, wherein reflective ink covers the surface of the lower layer circuit board.
